(19) United States
(12) Patent Application Publication
(10) Pub. No.: US 2003/0076364 A1
(43) Pub. Date: Apr. 24, 2003

(54) Method of previewing a graphical image corresponding to an icon in a clipboard

(75) Inventors: Anthony E. Martinez, Spicewood, TX (US); Michael D. Rahn, Rochester, MN (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY

(21) Appl. No.: 09/981,877

(22) Filed: Oct. 18, 2001

(51) Int. Cl. G09G 5/00

(52) U.S. Cl. 345/810

(57) ABSTRACT

A method of previewing a graphical image corresponding to an icon in a clipboard is provided. A paste command is received from a user. A determination is made whether a plurality of objects are stored within the clipboard. A clipboard may be displayed adjacent a display position indicator, if it is determined a plurality of objects are within the clipboard. An icon preview instruction is received from a user. A graphical image associated with the icon is displayed in response to the icon preview instruction.

### TECHNICAL FIELD OF THE INVENTION

In general, the invention relates to previewing a graphical image corresponding to an icon in a clipboard.

### BACKGROUND OF THE INVENTION

The use of a computer pointing device such as a mouse, trackball, or stylus pen are very common in computing today. One common use of a pointing device is to mark an object displayed on a computer screen for insertion into a clipboard. A clipboard is typically a temporary storage location in the computer that provides the user with a method of transferring data. Common commands associated with clipboards include cut, copy, and paste. The cut command instructs the computer to remove a marked object and place it in the clipboard. A copy command instructs the computer to place a copy of the object into the clipboard leaving the original object on the display. A paste command instructs the computer to place an object stored in the clipboard onto the display at a location indicated by the user. While there are other commands associated with clipboards, most are a variation of the cut, copy and paste commands.

In general, an operator will use a pointing device to move a display position indicator to an object shown on the display. By pressing control buttons on the pointing device and maneuvering the display position indicator, an object on the display may be marked. Once an object has been marked, it may be transferred into a clipboard using a cut or copy command. One method of executing a cut or copy command is to select a display icon representing the desired command. In some applications, the cut and copy icons may not be displayed until an edit window is displayed. Another method of executing a cut or copy command is by typing the desired command on a keyboard. Once the object has been placed in the clipboard, the user may indicate a location to insert the object by moving an insertion marker to the desired insertion location. The user may then execute a paste command by selecting a display icon representing the paste command or by typing the command on a keyboard.

One drawback with this method of transferring data to and from a clipboard is that if the clipboard contains more than one graphic image, the operator can't preview the images before selecting an image to insert into the document.

What is therefore needed is a method, which overcomes the above disadvantage.

### SUMMARY OF THE INVENTION

One aspect of the invention provides a method of previewing a graphical image corresponding to an icon in a clipboard. An icon preview instruction may be received from a user. The graphical image associated with the icon may be displayed in response to the icon preview instruction. An icon preview instruction may include determining whether a display position indicator is positioned over the icon displayed in the clipboard for a predetermined time period. Displaying the graphical image may include displaying a reduced image of the graphical image.

Another aspect of the invention provides a method of displaying a clipboard. A paste command may be received. A determination may be made whether a plurality of objects are stored within the clipboard. The clipboard may be displayed adjacent a display position indicator, if it is determined a plurality of objects are within the clipboard. The clipboard may be displayed such that an icon associated with a last pasted object is adjacent the display position indicator. The clipboard may be hidden in response to selecting an icon corresponding to an image stored on a clipboard. The clipboard may be hidden in response to moving position indicator so that the position indicator is not adjacent to the clipboard. The clipboard may be hidden in response to selecting a close icon on the clipboard.

Another aspect of the invention provides computer usable medium including a program for previewing a graphical image corresponding to an icon in a clipboard. The computer usable medium may include computer readable code for receiving an icon preview instruction from a user, and displaying the graphical image associated with the icon in response to the icon preview instruction. An icon preview instruction may include determining whether a display position indicator is positioned over the icon displayed in the clipboard for a predetermined time period. Displaying the graphical image may include displaying a reduced image of the graphical image.

Another aspect of the invention provides computer usable medium including a program for displaying a clipboard. The computer usable medium may include computer readable code for receiving a paste command, determining whether a plurality of objects are stored within the clipboard in response to the paste command, and displaying the clipboard adjacent a display position indicator, if it is determined a plurality of objects are within the clipboard. The clipboard may be displayed such that an icon associated with a last pasted object is adjacent the display position indicator. The clipboard may be hidden in response to selecting an icon corresponding to an image stored on a clipboard. The clipboard may be hidden in response to moving the position indicator so that the position indicator is not adjacent to the clipboard. The clipboard may be hidden in response to selecting a close icon on the clipboard.

The foregoing and other features and advantages of the invention will become further apparent from the following detailed description of the presently preferred embodiments, read in conjunction with the accompanying drawing.

### BRIEF DESCRIPTION OF THE DRAWINGS

FIG. 1 is a perspective view of one embodiment of a pop-up window for previewing a graphical image corresponding to an icon in a clipboard, in accordance with the present invention; and

FIG. 2 is a perspective view of one embodiment of a pop-up window for previewing a text image corresponding to an icon in a clipboard, in accordance with the present invention.

### DETAILED DESCRIPTION OF THE PRESENTLY PREFERRED EMBODIMENTS

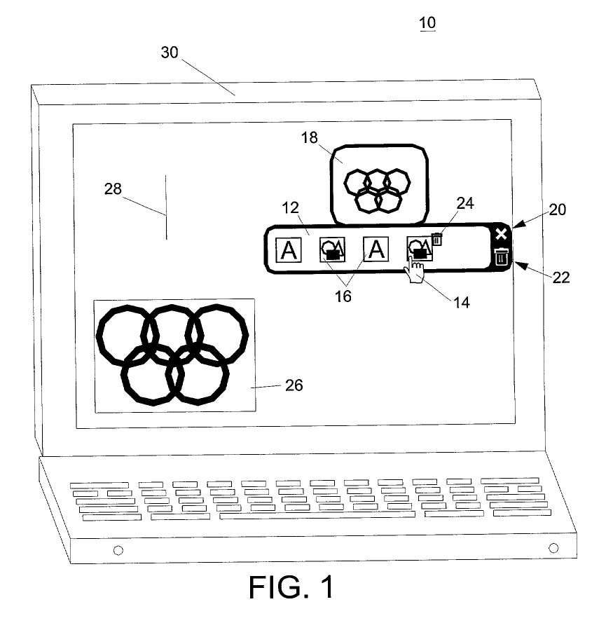

One embodiment of a method of previewing a graphical image corresponding to an icon in a clipboard is illustrated in FIG. 1 and designated in the aggregate as numeral 10. Upon receiving a paste command, a determination may be made whether a plurality of objects are stored within the clipboard. If it is determined a plurality of objects are within the clipboard, the clipboard may be displayed with the icon 16 associated with a last pasted object adjacent to the pointing device display position indicator 14. A preview instruction may result if a display position indicator 14 is positioned over an icon 16 displayed in the clipboard for a predetermined time. A reduced graphical image 18 associated with the icon may be displayed in response to the icon preview instruction.

The clipboard may be displayed in the form of a pop-up window 12. In one embodiment, the pop-up window 12 may include icons 16 representing items stored on the clipboard, a delete all objects icon 22, a delete a single item icon 24, and a close window icon 20.

The pop-up window 12 may include icons 16 representing items stored on the clipboard. In one embodiment, an icon 16 may show a graphic symbol if the associated item stored on the clipboard contains graphical images. The icon 16 may show a text symbol if the associated item stored on the clipboard contains only text. Those skilled in the art will recognize that the icons may show other features of the stored object including the file type, size, or any other desired information.

The pop-up window 12 may include a control to delete all items from the clipboard. In one embodiment, the pop-up window 12 may include a delete all objects icon 22. The delete all objects icon 22 may show a recycle bin or other symbol to represent deletion. Selecting the delete all icon 22 may result in the deletion of all items stored on the clipboard.

The pop-up window 12 may include a control to delete a single item from the clipboard. In one embodiment, the pop-up window 12 may include a delete a single item icon 24. The delete a single item icon 24 may show a recycle bin or other symbol that represents deletion. The delete a single item icon 24 may be displayed adjacent to an icon 16 representing an item stored in the clipboard. Selecting the delete a single item icon 24 may result in the item represented by the icon 16 adjacent to the delete a single item icon 24 being deleted. Upon selecting a delete a single item icon 24, both the delete a single item icon 24 selected and the icon 16 representing the deleted item may be removed from the pop-up window 12.

The pop-up window 12 may include a control to remove the pop-up window from the display. In one embodiment, the pop-up window 12 may include a close window icon 20. The close window icon 20 may show an “X” or other symbol indicating the pop-up window 12 will close if the icon 20 is selected. The close window icon 20 may be located in the upper right hand corner of the pop-up window 12. Selecting the close window icon 20 may result in the pop-up window 12 being removed from the display.

In one embodiment, an object 26 on a display screen of a computer 30 may be marked using a pointing device. The object 26 may include text or graphics displayed on a computer screen. A copy command may be executed to transfer the marked object 26 onto a clipboard. An insertion marker 28 may be positioned on a display screen where an item stored on the clipboard is to be inserted. A paste command may be executed to transfer an object stored on a clipboard to the insertion marker 28 location.

In one embodiment, if more than one item is stored on the clipboard, a clipboard pop-up window 12 may be displayed on the display of the computer 30. The clipboard pop-up window 12 may be displayed in a position such that the icon 16 representing the last item stored on the clipboard will be adjacent to the pointing device display position indicator 14. If the last item stored on the clipboard is not paste-able into the location indicated by the insertion marker 28, the clipboard may be positioned so that the icon 16 representing the last paste-able item stored on the clipboard will be display adjacent to the display position indicator 14. If the display position indicator 14 is positioned adjacent to an icon 16 representing an item stored on the clipboard for a pre-determined amount of time, a preview of the image represented by the icon selected may be displayed 18.

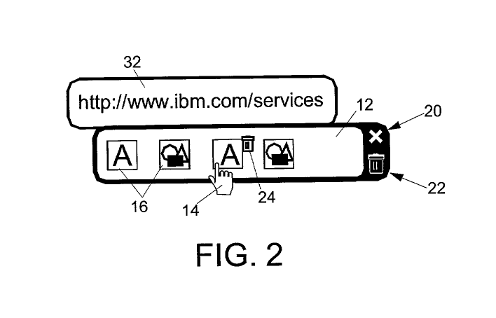

Referring to FIG. 1 and FIG. 2, if the icon selected represents text stored in the clipboard, the preview may include a text box 32 showing a predetermined number of the text characters stored on the clipboard. If the icon selected represents a graphical image stored on the clipboard, a reduced image 18 of the image stored in the clipboard may be shown. If the display position indicator 14 is moved to another icon 16 in the pop-up window 12, the item represented by the icon may be immediately previewed. An item may be inserted at a location specified by a insertion marker 28 by pressing the select button (not shown) on a pointing device (not shown) when the display position indicator 14 is adjacent to the icon 16 representing the item.

In one embodiment, the pop-up window 12 may be removed from the display by performing one of a group of actions including; selecting the close window icon 20, moving the display position indicator 14 so that the display position indicator 14 is not adjacent to the pop-up window 12, and pressing the escape button on the keyboard.

While the embodiments of the invention disclosed herein are presently considered to be preferred, various changes and modifications can be made without departing them the spirit and scope of the invention. The scope of the invention is indicated in the appended claims, and all changes that come within the meaning and range of equivalents are intended to be embraced therein.

1. A method of previewing a graphical image corresponding to an icon in a clipboard, comprising:
receiving an icon preview instruction from a user; and
displaying the graphical image associated with the icon in response to the icon preview instruction.

2. The method of claim 1 wherein receiving an icon preview instruction comprises determining whether a display position indicator is positioned over the icon displayed in the clipboard for a predetermined time period.

3. The method of claim 1 wherein displaying the graphical image comprises displaying a reduced image of the graphical image.

4. A method of displaying a clipboard comprising:
receiving a paste command;
determining whether a plurality of objects are stored within the clipboard in response to the paste command; and
displaying the clipboard adjacent a display position indicator, if it is determined a plurality of objects are within the clipboard.

5. The method of claim 4 wherein displaying the clipboard adjacent the display position indicator comprises positioning an icon associated with a last pasted object adjacent the display position indicator.

6. The method of claim 4 further comprising:
hiding the clipboard in response to selecting an icon corresponding to an image stored on a clipboard.

7. The method of claim 4 further comprising:
hiding the clipboard in response to moving position indicator so that the position indicator is not adjacent to the clipboard.

8. The method of claim 4 further comprising:
hiding the clipboard in response to selecting a close icon on the clipboard.

9. Computer usable medium including a program for previewing a graphical image corresponding to an icon in a clipboard, comprising:
computer readable code for receiving an icon preview instruction from a user; and
computer readable code for displaying the graphical image associated with the icon in response to the icon preview instruction.

10. The computer usable medium of claim 9 wherein receiving an icon preview instruction comprises determining whether a display position indicator is positioned over the icon displayed in the clipboard for a predetermined time period.

11. The computer usable medium of claim 9 wherein displaying the graphical image comprises displaying a reduced image of the graphical image.

12. Computer usable medium including a program for displaying a clipboard comprising:
computer readable code for receiving a paste command;
computer readable code for determining whether a plurality of objects are stored within the clipboard in response to the paste command; and
computer readable code for displaying the clipboard adjacent a display position indicator, if it is determined a plurality of objects are within the clipboard.

13. The computer usable medium of claim 12 wherein displaying the clipboard adjacent the display position indicator comprises positioning an icon associated with a last pasted paste-able object adjacent the display position indicator.

14. The computer usable medium of claim 12 further comprising:
hiding the clipboard in response to selecting an icon corresponding to an image stored on a clipboard.

15. The computer usable medium of claim 12 further comprising:
hiding the clipboard in response to moving position indicator so that the position indicator is not adjacent to the clipboard.

16. The computer usable medium of claim 12 further comprising:
hiding the clipboard in response to selecting a close icon on the clipboard.
